(19) United States
(12) Patent Application Publication
(10) Pub. No.: US 2020/0205444 A1
(43) Pub. Date: Jul. 2, 2020

(54) PROCESS AND FORMULATION OF POWDERED SWEET LIME FRUIT JUICE WITH ENHANCED REAL FRUIT CONTENT AND STABILITY

(71) Applicant: YOGEE'S BIOINNOVATIONS PRIVATE LIMITED, HYDERABAD (IN)

(72) Inventors: Yogeeswari PERUMAL, Hyderabad (IN); Raghav SRIRAM YOGEESWARI, Hyderabad (IN); Srikanth KATTABOYINA, Hyderabad (IN)

(21) Appl. No.: 16/647,063

(22) PCT Filed: Sep. 17, 2018
(86) PCT No.: PCT/IN2018/050603

§ 371 Date: Mar. 13, 2020

(30) Foreign Application Priority Data
Sep. 16, 2017 (IN) 201741009190

(51) Int. Cl. A23L 2/12; A23L 2/44; A23L 2/395; A23L 33/15; A23L 29/00; A23L 29/269; A23L 33/29

(52) U.S. Cl. CPC A23L 2/12; A23L 2/44; A23L 2/395; A23L 33/29; A23L 29/015; A23L 29/273; A23L 33/15

(57) ABSTRACT

A formulation of powdered sweet lime fruit juice with enhanced real fruit content and stability is provided. Also provided is a process for preparation of stable dried powdered sweet lime fruit juice wherein maximum fruit content with natural nutritional components has been retained.

### CROSS-REFERENCE TO RELATED APPLICATIONS

This application claims priority to PCT Application No. PCT/IN2018/050603, having a filing date of Sep. 17, 2018, based on IN 201741009190, having a filing date of Sep. 16, 2017, the entire contents both of which are hereby incorporated by reference.

### FIELD OF TECHNOLOGY

The following relates to the stable sweet lime juice formulation retaining more than 94% of real fruit components; and the process thereof.

### BACKGROUND

Fruits are important sources of vitamins and carbohydrates including fiber and sugar. They are low in calories and naturally sweet. Fruits and their juices are good sources of water too. Different fruits contain different vitamins, so it is important to eat a variety of fruits. There is no harm of taking lots of fruits because it will supply us all kind of vitamins which is needed by our body. These vitamins are very important for human being as a supplement and to avoid various kind of sickness. Citrus fruits have been known to have many benefits both when taken internally and for external applications. Fresh fruit juices typically contain about 85-98% of water. This high water content places a heavy burden on the packaging, handling, storing and shipping of such juices and has stimulated the development of many processes for the partial or complete dehydration of such juices.

Nowadays, the fast economic development has changed the trend of food consumption from calories assurance to diet nutrient enrichment. The consumers today are well educated and well aware of importance of vitamins. This scenario has increased the global market demand towards the fresh fruits. In order to meet the market demand throughout the year in all areas; the fresh fruits is preserved using different techniques. High moisture content in fruit leads towards decrease of quality due to water activity. So, drying of fruits is used to remove the moisture content which decreases the water activity and hence, increases the quality of the fruits. Drying is an ancient technique of preservation which is still being applied in this modern world.

Fruit juices are processed in a variety of forms for human consumption in the market with not more than 20-30% of real fruit content with added flavours, artificial color, sweeteners and preservatives in the market (Technopak report; http://www.technopak.com/Files/packaged-juice-market-in-india.pdj). Among the juices, citrus juices are the most preferred among the community for human consumption due to their Vitamin C content.

The Sweet lime (Citrus limetta risso) is commonly known as mousambi fruit in India. Sweet limes are one of the best fruit sources of the mineral sodium, beneficial for elimination of waste, cleaning of the lymphatic system and healthy digestive system. Sweet limes are also an excellent source of phosphorous, required for a healthy functioning nervous system. Limes and other citrus fruits are rich in potassium, a mineral which assists to keep blood pressure low. Limes also contain vitamin C, folate, fiber and phytonutrients that are important as antioxidants and maintain immune functions in the body.

The major challenges involved in the processing of fruit juice into dried powder are the hygroscopicity due to the presence of fruit sugars and glass transition temperature. Various antihygroscopic agents have been employed in various fruit products. U.S. Pat. No. 3,250,607 discloses the use of various silicates as antihygroscopic substances and EP0515110 discloses citrates as anticaking agents. Both silicates and citrates have not been explored with sweet lime juice.

WO2013140382 discloses a formulation of a natural fruit juice powder mix with value added dietary fibers and retention of nutritional quality along with various fruit juices such as mix having tender coconut and citrus fruit (lemon, orange, kinno, sweet lime), Coconut-Orange, Coconut-Pineapple, Coconut-Mixed fruit, Coconut-Litchi or combination thereof. WO2013140382 discloses a spray drying technology wherein fruit juice is atomized and allowed to fall under gravity without being adhered to the walls of dryer chamber, collecting the dried fruit powder at the bottom of the dryer. This process discloses the use of maltodextrin as stabilizer.).

U.S. Pat. No. 4,112,130 discloses a method of producing citrus juice powder of orange by employing spray drying technology along with food grade dextrins as drying aid. U.S. Pat. No. 3,298,838 discloses a process for citrus fruit juice powder which involves addition of food coloring and vitamin C additives. U.S. Pat. No. 2,816,039 discloses evaporation procedures for drying fruit juices of grape and apple). U.S. Pat. No. 2,367,131 discloses a pasteurization technique followed by spray drying under vacuum to produce lemon juice powder; and this process involves various chemical treatment steps including treatment with sulfur dioxide. U.S. Pat. No. 2,255,341 discloses addition of boric acid and buffer to enhance the attractiveness and color of dried lemon juice.

There are no reports on the stable sweet lime juice powder in the market. The stabilizers employed in other citrus fruits like orange and lemon juice has been mostly dextrins. The process reported for drying of fruit juices are mostly spray drying or vacuum or pasteurization. Sweet lime products available in the market are packaged drinks with less than 6% real sweet lime concentrate in every 100 ml.

Embodiments of the present invention relates to sweet lime fruit juice powder retaining more than 94% of real fruit components and with no artificial additives for flavour or color. Embodiments of the present invention also relates to the production of high quality sweet lime juice powder retaining upto 98% of the fruit content using freeze-drying technology and by using 2% of FDA approved food grade stabilizer other than dextrins as reported in other inventions to counteract the hygroscopicity of fruit juice powder.

### SUMMARY

An aspect relates to a stable fruit juice formulation comprising sweet lime fruit juice powder and an anticaking agent, wherein the formulation does not contain artificial additives for flavor or color.

Another aspect of embodiments of the invention is to provide a stable sweet lime fruit juice formulation retaining more than 94% of real fruit components at room temperature for upto 2 years.

Yet another aspect of embodiments of the invention is to provide a process for the preparation of stable sweet lime juice formulation.

Accordingly, embodiments of the present invention relates to process and formulation of powdered sweet lime fruit juice with enhanced real fruit content and stability.

In one aspect of embodiments of the invention, there is provided a stable fruit juice formulation retaining more than 94% of real fruit components at room temperature for upto 2 years, comprising sweet lime fruit juice powder and an anticaking agent, wherein the formulation does not contain artificial additives for flavor or color.

In some embodiment, there is provided a stable fruit juice formulation retaining more than 98% of real fruit components at room temperature for upto 2 years, comprising sweet lime fruit juice powder and an anticaking agent, wherein the formulation does not contain artificial additives for flavor or color.

In some embodiment, the anticaking agent present in the above described sweet lime juice formulation is in an amount of 0.25-6% w/w. In an embodiment, the anticaking agent present in the above described sweet lime juice formulation is in an amount of 0.25-2% w/w. In another embodiment, the anticaking agent is selected from tricalcium phosphate, cyclodextrins, silicon dioxide, calcium silicate or the like.

The stable fruit juice formulation according to embodiments of the invention is reconstituted with water before consumption.

The stable fruit juice formulation according to embodiments of the invention is formulated as liquid, powder, granules, pellets, tablets, capsules or the like.

In embodiments of the invention, the stable fruit juice formulation as described above further comprises one or more ingredients selected from minerals, vitamins or other nutritive ingredient.

In another aspect, there is provided a stable sweet lime fruit juice powder comprising 4.92 g of sweet lime fruit juice powder and 0.08 g of silicon dioxide. In some embodiment, the sweet lime fruit juice powder is reconstituted with 150 ml of water before consumption.

In yet another aspect, there is provided a process for the preparation of stable fruit juice formulation according to embodiments of the the invention, the process comprising:
a) mixing fresh sweet lime juice along pulp with one or more anticaking agent;
b) deep freezing the mixture obtained in step-a under −80° C. overnight; and
c) vacuum enabled freeze drying at −98° C. for 48-120 hours to obtain the sweet lime fruit juice powder.

In another aspect, the stable fruit juice according to embodiments of the invention can be used as sugar free coating material for pharmaceutical preparations. In some embodiments, the formulation according to embodiments of the invention can be used as sugar free vitamin C enriched coating material for pharmaceutical preparations and health supplements. In some other embodiments, the formulation according to embodiments of the invention can be used as sugar free, vitamin C enriched natural flavoring agent in any pharmaceutical preparation, food or health supplement and beverage.

### DETAILED DESCRIPTION

Embodiments of the present invention relates to process and formulation of powdered sweet lime fruit juice with enhanced real fruit content and stability. More particularly the present invention relates to the process of dried powdered sweet lime fruit juice in order to retain maximum fruit content with natural nutritional components and also with a better stability and shelf life. The purpose of drying of sweet lime fruit juice is to produce a stable and easily handled form of juice, which reconstitutes rapidly to a quality product resembling the original juice as closely as possible with real fruit juice and pulp content in the range of 94-99%. Also, for fruit juice powder production two complex problems pose as challenges: the stickiness of powder and its handling, and the natural characteristics of fruit juice prevented powder production. Embodiments of the present invention also relates to the compositions thereof for the processing of the sweet lime juice into the powdered formulations. Method for free-flowing sweet lime juice powder having improved fruit content, flavour, nutritional components with a very minimal addition of up to 2% stabilizer providing an option for real fruit up to 98% water soluble ready to reconstitute with water for making real fruit juice for human consumption.

Embodiments of the present invention is directed to produce high quality sweet lime fruit juice powder in combination with various natural food additives as anti-drying/caking and stabilizers which are other than usual dextrins.

In one aspect of embodiments of the invention, there is provided a stable fruit juice formulation retaining more than 94% of real fruit components at room temperature for upto 2 years, comprising sweet lime fruit juice powder and an anticaking agent, wherein the formulation does not contain artificial additives for flavor or color.

In some embodiment, there is provided a stable fruit juice formulation retaining more than 98% of real fruit components at room temperature for upto 2 years, comprising sweet lime fruit juice powder and an anticaking agent, wherein the formulation does not contain artificial additives for flavor or color.

In some embodiment, the anticaking agent present in the above described sweet lime juice formulation is in an amount of 0.25-6% w/w. The anticaking agent present in the above described sweet lime juice formulation is in an amount of 0.25-2% w/w. In another embodiment, the anticaking agent is selected from tricalcium phosphate, cyclodextrins, silicon dioxide, calcium silicate or the like.

The stable fruit juice formulation according to embodiments of the invention is reconstituted with water before consumption.

The stable fruit juice formulation according to embodiments of the invention is formulated as liquid, powder, granules, pellets, tablets, capsules or the like.

In another aspect, there is provided a stable sweet lime fruit juice powder comprising 4.92 g of sweet lime fruit juice powder and 0.08 g of silicon dioxide. In some embodiment, the sweet lime fruit juice powder is reconstituted with 150 ml of water before consumption.

In yet another aspect, there is provided a process for the preparation of stable fruit juice formulation according to embodiments of the invention, the process comprising:
a) mixing fresh sweet lime juice along pulp with one or more anticaking agent;
b) deep freezing the mixture obtained in step-a under −80° C. overnight; and
c) vacuum enabled freeze drying at −98° C. for 48-120 hours to obtain the sweet lime fruit juice powder.

Embodiments of the present invention involves a process of making sweet lime juice powder using freeze-drying technology under vacuum employing anticaking agent like silicon dioxide or tricalcium phosphate or beta cyclodextrins in the range of 0.25-2% w/v of the juice yielding a stable free flowing sweet lime juice powder which is water soluble and ready to reconstitute as real fruit juice with no additional additives or artificial flavours or colors retaining more than 94% real fruit components which is a healthier option compared to the marketed packaged drinks or juice powders which has real fruit content ranging from 0.4-30%.

The preparation of formulation according to embodiments of the invention comprises addition of silicon dioxide as anticaking agent either singly or in combination with tricalcium phosphate in the ratio ranging from 1:0.25 to 1:1 to fresh sweet lime juice. In some other embodiment, the preparation of formulation according to embodiments of the invention comprises addition of calcium silicate as anticaking agent either singly or in combination with silicon dioxide in the ratio ranging from 1:0.5 to 1:1 to fresh sweet lime juice.

The process involves deep freezing of the fresh sweet lime juice with pulp along with various food grade stabilizers (0.25-2% w/v) other than the usual maltodextrins like silicon dioxide, tricalcium phosphate, betacyclodextrin or cellulose (powdered or microcrystalline) under −80° C. overnight followed by vacuum enabled freeze drying at −98° C. for 48 hours to 120 hours.

The sweet lime juice powder thus prepared with no heat retains the nutritional components and has a shelf life of more than two years.

In embodiments of the invention, the stable fruit juice formulation as described above further comprises one or more ingredients selected from minerals, vitamins or other nutritive ingredient. For example, the sweet lime juice powder formulation further comprises fortified nutrients like calcium in the form of tricalcium phosphate.

Embodiments of the invention also includes various formulation of sweet lime juice powder with various additional natural components like ginger, fennel, cumin, pepper and other natural spices to cater to the various preferences of consumer taste in beverages and food consumables.

The high quality sweet lime juice can be utilized as consumer food beverage, by food industry for using as alternative synthetic flavours, for pharmaceutical manufacturing of nutrition products and as a coating material in place of sugar coating.

In another aspect, the stable fruit juice according to embodiments of the invention can be used as sugar free coating material for pharmaceutical preparations. In some embodiments, the formulation according to embodiments of the invention can be used as sugar free vitamin C enriched coating material for pharmaceutical preparations and health supplements. In some other embodiments, the formulation according to embodiments of the invention can be used as sugar free, vitamin C enriched natural flavoring agent in any pharmaceutical preparation, food or health supplement and beverage.

The sweet lime juice powder formulation of embodiments of the the present invention has the following advantages:

a) Provides sweet lime juice powder with about 94-99.75% real fruit components (sweet lime juice powder is not available in the market with more than 90% real fruit components);

b) The sweet lime juice powder is stabilized using non-dextrin food additive to a free flowing powder ready to be reconstituted into juice as they are water soluble. This is advantageous when compared to fresh fruits which are perishable and have limited shelf life;

c) The sweet lime juice powder is processed under no heat and free drying under vacuum yields the juice powder wherein more than 94% of nutritional supplements are retained; and

d) Being in a dried form, the sweet lime juice powder has an extended shelf life of more than 24 months as compared to the packaged sweet lime juice products whose shelf life is less than 3 months if unopened, but less than a week if opened.

### EXAMPLES

### Example 1: Preparation of Sweet Lime Juice Powder Formulation

Silicon dioxide (0.06 g) was added to every 30 ml of fresh sweet lime juice and deep freezing was carried at a temperature of −80° C. This was further dried through non-heat freeze drying technology to obtain crystalline, free flowing, high quality (more than 98% juice content) and stabilized sweet lime powder with shelf life up to 2 years. The powder was freely soluble in water and can be reconstituted with water. Every 5 g of sweet lime powder when added with a little stirring in 150 ml of water can be consumed as an alternative to fresh sweet lime juice or marketed packaged juices with low real fruit content.

The composition of the obtained sweet lime juice powder after freeze drying included 3.8 g of sweet lime juice powder and 0.06 g of silicon dioxide, making it 98.44% sweet lime fruit juice powder. Every 5 g of such composition comprised 4.2 g of sweet lime juice powder and 0.08 g of silicon dioxide.

### Example 2: Preparation of Sweet Lime Juice Powder Formulation

Silicon dioxide (0.06 g) in combination with tricalcium phosphate (0.075 g) was added to every 30 ml of fresh sweet lime juice and deep freezing was carried at a temperature of −80° C. This was further dried through non-heat freeze drying technology to obtain crystalline, free flowing, high quality (more than 95% juice content) and stabilized powder with shelf life upto 2 years. The obtained powder of sweet lime juice can be reconstituted as 5 g per 150 ml of water to be consumed as an alternative to fresh sweet lime juice. Due to solubility issues with tricalcium phosphate, the juice becomes turbid.

The composition of the obtained sweet lime juice powder after freeze drying included 3.60 g of sweet lime juice powder, 0.06 g of silicon dioxide and 0.075 g of tricalcium phosphate making it 96% sweet lime fruit juice powder.

### Example 3: Preparation of Sweet Lime Juice Powder Formulation

Calcium silicate (0.03 g) in combination with silicon dioxide (0.15 g) was added to every 30 ml of fresh sweet lime juice and deep freezing was carried at a temperature of −20° C. This was further dried through non-heat freeze drying technology to yield crystalline, free flowing, high quality (about 94% juice content) and stabilized powder with shelf life upto 2 years.

The composition of the obtained sweet lime juice powder after freeze drying included 2.84 g of sweet lime juice powder, 0.03 g of calcium silicate and 0.15 g of silicon dioxide making it 94% sweet lime fruit juice powder.

### Example 4: Preparation of Sample for Freeze Drying

The fresh sweet lime juice was extracted along with the pulp by removing the seeds, tough fibers and the tough rind. The collected fresh juice along with the thick pulp was measured for volume and based on the outcome of freeze dried powder amount, anticaking agent like silicon dioxide or calcium silicate or others as listed were added ranging from 0.25-2% singly or in combination keeping in mind the limit as prescribed for food additives by WHO or FAO or FDA. The mixture was taken in a freeze drying tray or flask and pre-freezed overnight at −20 to −80° C. The freeze drying was performed either at −55° C. or −98° C. under vacuum for about 40-120 h.

### Example 5: Stability of the Sweet Lime Juice Powder

The sweet lime juice powder prepared along with 0.25-2% of anticaking natural additives has an improved storage stability which can retain their organoleptic properties, such as flavor, taste and aroma, substantially unaltered with the course of time. The moisture content of the dried sweet lime juice powder was about 4-4.5%. The relatively low moisture content obviously assisted in the extension of the shelf-life. The powder packed in vacuum sealing showed improved stability up to 20-24 months. The stability was better in laminated packages with no change in the color and appearance with no caking.

Although the invention has been illustrated and described in greater detail with reference to the preferred exemplary embodiments, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

1. A stable fruit juice formulation retaining more than 94% areal fruit components at room temperature for up to 2 years, comprising: sweet lime fruit juice powder and an anticaking anent, wherein the formulation does not contain artificial additives for flavor or color.

2. The stable fruit juice formulation as claimed in claim 1, wherein the formulation retains more than 98% of real fruit components.

3. The stable fruit juice formulation as claimed in claim 1, wherein the anticaking agent is present in an amount of 0.25-6% w/w.

4. The stable fruit juice formulation as claimed in claim 3, wherein the anticaking agent is present in an amount of 0.25-2% w/w.

5. The stable fruit juice formulation as claimed in claim 3, wherein the anticaking agent is selected from tricalcium phosphate, cyclodextrins, silicon dioxide, calcium silicate or the like.

6. The stable fruit juice formulation as claimed in claim 1, wherein the formulation is reconstituted with water before consumption.

7. The stable fruit juice formulation as claimed in claim 1, wherein the formulation is formulated as liquid, powder, granules, pellets, tablets, capsules or the like.

8. The stable fruit juice formulation as claimed in claim 1, further comprising one or more ingredients selected from the group consisting of minerals, vitamins and other nutritive ingredient.

9. The stable fruit juice formulation as claimed in claim 1, wherein the formulation can be used as sugar free coating material for pharmaceutical preparations.

10. The stable fruit juice formulation as claimed in claim 1, wherein the formulation can be used as sugar free vitamin C enriched coating material for pharmaceutical preparations and health supplements.

11. The stable fruit juice formulation as claimed in claim 1, wherein the formulation can be used as sugar free, vitamin C enriched natural flavoring aunt in any pharmaceutical preparation, food or health supplement and beverage.

12. A stable sweet lime fruit juice powder comprising:
Sweet lime fruit juice powder: 4.92 g
Silicon dioxide: 0.08 g

13. The powder as claimed in claim 12, wherein the powder is reconstituted with 150 ml of water before consumption.

14. A process for manufacturing the stable fruit juice formulation as claimed in claim 1, wherein the process comprises:
d) mixing fresh sweet lime juice along pulp with one or more anticaking agent,
e) deep freezing the mixture obtained in step-a under −80° C. overnight; and
c) vacuum enabled freeze drying at −98° C. for 48-120 hours to obtain the sweet lime fruit juice powder.
